(19) United States
(12) Patent Application Publication
(10) Pub. No.: US 2016/0357260 A1
(43) Pub. Date: Dec. 8, 2016

(54) DISTANCE INDEPENDENT GESTURE DETECTION

(71) Applicant: STMICROELECTRONICS (RESEARCH & DEVELOPMENT) LIMITED, Marlow (GB)

(72) Inventors: Jeffrey M RAYNOR, EDINBURGH (GB); Andrew HODGSON, EDINBURGH (GB)

(21) Appl. No.: 14/729,462

(22) Filed: Jun. 3, 2015

(51) Int. Cl. G06F 3/01; G06F 3/0354

(52) U.S. Cl. CPC G06F 3/017; G06F 3/03543

(57) ABSTRACT

A method for measuring motion may include moving an object in a field of view of an image sensor array, producing two-dimensional motion information of the object from an output of the image sensor array, and measuring a distance between the object and the image sensor array. The method may further include correcting the motion information based on the measured distance.

### TECHNICAL FIELD

This disclosure relates to human-machine interfaces, and more particularly to a gesture detection system.

### DESCRIPTION OF THE RELATED ART

Touch-screens are widely used as human-machine interfaces. The operation of a touch-screen relies upon physical contact with the screen, usually with the fingers of the user. The screen may thus be subject to wear due to friction and to soiling by materials adhering to the fingers.

Other human-machine interfaces, such as optical mice, may operate without physical contact with a sensor. The sensor is in the form of an image sensor array (typically 20×20 pixels) configured to observe the surface over which the mouse is moved. The absence of contact with the sensor provides for an absence of wear and cleaning. Optical mice are, however, not convenient for use with mobile or hand-held electronic devices.

The operation principle of an optical mouse has been adapted to “finger-mice” that are usable in hand-held devices. The image sensor is then configured to observe an imaging surface over which the finger is moved. Such a device also relies upon a physical contact of the finger on the imaging surface.

Yet, other human-machine interfaces may detect movement and gestures without contact using depth-sensor techniques and structured light, such as disclosed in U.S. Patent Pub. No. 2010/0199228. However, these interfaces are relatively complex and generally not well suited for use with hand-held devices.

### SUMMARY

In an example embodiment, a method is provided for measuring motion which may include moving an object in a field of view of an image sensor array, producing two-dimensional motion information of the object from an output of the image sensor array, and measuring a distance between the object and the image sensor array. The method may further include correcting the motion information based on the measured distance.

The method may also include measuring the distance with an optical time of flight sensor. The method may further include producing a two-dimensional motion vector as the motion information, correcting the motion vector linearly based on the measured distance, and adding a third dimension to the corrected motion vector based on the measured distance.

Additional steps may include responding to the corrected motion information when the measured distance is below a threshold, and ignoring the motion information when the measured distance is above the threshold. Furthermore, the method may also include responding to the corrected motion information when the measured distance is above a threshold, and ignoring the motion information when the measured distance is below the threshold.

An embodiment of a system for measuring motion of an object may include an image sensor array, a distance sensor configured for measuring a distance between the object and the image sensor array, and a motion sensor connected to the image sensor array for producing motion information of the object. A correction circuit may be connected to the motion sensor and the distance sensor for correcting the motion information based on a distance measure produced by the distance sensor.

The system may include an optical time of flight sensor as the distance detector, and a pulsed infrared laser emitter. Moreover, the optical sensor and the image sensor may be responsive to the infrared laser emitter.

### BRIEF DESCRIPTION OF THE DRAWINGS

Other potential advantages and features of various embodiments will become more apparent from the following description of particular embodiments provided for exemplary purposes only and represented in the appended drawings, in which:

FIG. 1 is a schematic representation of an embodiment of a contactless gesture detection device according to an example embodiment;

FIG. 2 is a block diagram of exemplary processing circuitry for the gesture detection device of FIG. 1; and

FIG. 3 is a schematic diagram of an optical system for the gesture detection device of FIG. 1.

### DETAILED DESCRIPTION

As mentioned above, most conventional gesture detection systems adapted to hand-held devices require touching a screen. A gesture detection system is disclosed herein that requires no contact with a screen, and that is relatively simple and robust for use in a hand-held device.

Such a system may be based on the operation principle of a finger-mouse. The imaging surface of the conventional finger-mouse is however omitted, whereby the user's hand or a pointer object may move at an arbitrary distance from the sensor. The depth of field of the lens or optical system of the sensor may be sufficient to discriminate motion of the pointer object over a wide range of distances from the sensor. However, the size of the image captured by the sensor varies with the distance of the object from the sensor, whereby the motion information produced by the sensor is not representative of the actual motion of the object.

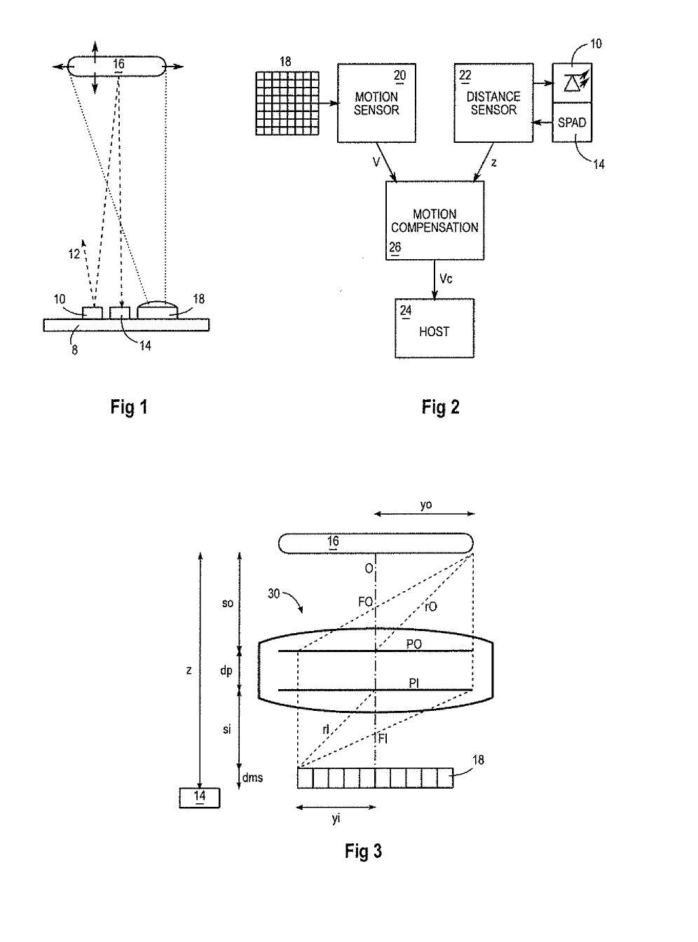

To overcome this difficulty, a distance sensor may be associated with the image sensor to measure the distance between the object and the sensor, and to correct the motion information output by the motion sensor. An exemplary mechanical configuration of such a system is schematically illustrated in FIG. 1. The distance sensor may be an optical time-of-flight sensor including, on a substrate 8, an infrared radiation source 10 emitting photons 12 substantially perpendicularly to the substrate. A photon detector 14 is arranged on the substrate close to the emitter 10 for receiving photons reflected from a pointer object 16 moving over the substrate 8. The detector 14 may be based on so-called Single Photon Avalanche Diodes (SPAR), such as disclosed in U.S. Patent Pub. No. 2013/0175435 to Drader (which is hereby incorporated herein in its entirety by reference), using a pulsed infrared laser emitter.

A control circuit (not shown) energizes the transmitter 10 with relatively short duration pulses and observes the signal from the detector 14 to determine the elapsed time between each pulse and the return of a corresponding burst of photons on the detector 14. The circuit thus measures the time of flight of the photons along a path going from the emitter 10 to the object 16 and returning to the detector 14. The time of flight is proportional to the distance between the object and the detector, and does not depend on the intensity of the received photon flux, which varies depending on the reflectance of the object and the distance.

An image sensor array 18 may be mounted on the substrate and oriented to observe the object 16 in its field of view. It may be located close to the distance sensor elements 10 and 14. The image sensor 18, like a conventional finger-mouse sensor, may also operate in the infrared wavelengths and thus use the same light source 10 as the distance sensor.

FIG. 2 is a block diagram of exemplary processing circuitry for a gesture detection device of the type shown in FIG. 1. The output of the image sensor array 18 is provided to motion sensor circuitry 20. The array 18 and the motion sensor techniques implemented by circuitry 20 may be those used in a conventional finger-mouse. The array 18 typically includes 20×20 pixels, although other sizes may also be used. The motion sensor circuitry 20 may produce motion information in the form of a two-dimensional vector V each time it is sampled by a downstream circuit. The vector V thus has an x-component and a y-component. Each component may be in the form of a pixel count that corresponds to the number of pixels by which the image captured by the sensor array 18 has moved in the corresponding direction since the last sampling. A speed vector may thus be obtained by dividing the x- and y-components by the sampling time.

The infrared emitter 10 and the SPAD detector 14 are controlled by a distance sensor circuit 22. The circuit 22 produces distance information z.

In a conventional system using a finger-mouse, the motion vector V may be provided to a host processor 24 that would take appropriate actions with the information. In this embodiment, the motion vector V is provided to a motion compensation circuit 26 that also receives the distance information z from the distance sensor 22.

The motion compensation circuit 26 is configured to correct the motion vector V to take into account the distance z. The circuit produces a corrected vector Vc for the host processor 24. The correction applied to vector V may be such that vector Vc represents the actual motion of the object rather than the motion of its image as captured by the image sensor 18, i.e., such that the vector Vc is independent of the distance of the object.

FIG. 3 is a schematic diagram of an optical system that may be used in the gesture detection device of FIG. 1. The optical system 30 may have multiple lenses which are represented by two principal planes, a plane PO on the object side, and a plane PI on the image side. The intersections of the planes PO and PI with the optical axis O define, respectively, an object nodal point and an image nodal point. The object and image nodal points have the property that a ray aimed at one of them will be refracted by the optical system such that it appears to have come from the other nodal point, and with the same angle with respect to the optical axis. This is illustrated by a ray rO between the right edge of object 16 and the object nodal point, and a ray rI between the image nodal point and the left edge of image sensor array 18.

In addition, a ray from the right edge of object 16 enters the optical system parallel to the optical axis and is refracted at principal plane PI towards the left edge of array 18. The intersection of the refracted ray with the optical axis is the image focal point FI. The refracted ray and ray rI intersect in the image plane represented by the top face of array 18, meaning that the system is in focus. Under those conditions, a ray leaving the right edge of the object 16 and crossing the object focal point FO, as shown, is refracted parallel to the optical axis at the principal plane PO and also intersects ray rI in the image plane.

The corrected motion vector Vc may be expressed by:

Vc=V/G,

where G is the magnification of the optical system. The magnification in FIG. 3 may be expressed by:

G=yi/yo=si/so,

where yi is the length of a feature in the image plane, for instance a pixel of the sensor array, and yo the length of the corresponding feature in the object plane. The values so and si respectively designate the distance between the object and the principal plane PO, and the distance between the image plane and the principal plane PI.

The distance between the planes PI and PO is designated by dp. Finally, as shown, the distance sensor 14 may be offset from the image plane by a signed distance dms. Thus the distance z produced by the distance sensor is expressed by:

z=so+dp+si+dms,

yielding

so=z−dp−si−dms.

The magnification may also be expressed as:

G=si/(z−dp−si−dms),

yielding the following expression for the corrected vector:

Vc=(z−dp−si−dms)·V/si.

The corrected vector as expressed above is a linear function of the distance z, assuming that the optical system or lens has a fixed focus, whereby parameters si, dp and dms are constant. A fixed focus lens may indeed be used for a wide range of distances, because the system will tolerate a certain degree of blurring for detecting motion. Moreover, the system may use a lens having a small focal distance (e.g., a few millimeters) that may focus sharply from a small distance (e.g., a few centimeters) to the infinite. In fact, since the original motion vector V produces a pixel count rather than a distance, using the magnification factor as expressed above may not be adapted to downstream processing techniques that expect pixel counts within a specific range.

The motion vector may then be compensated by a factor Gref equal to the magnification obtained when the object is at a reference distance from the image sensor (e.g., the distance at which the image is in focus), which may be chosen as the most likely distance of the object or, alternatively, as the closest distance. This would yield:

Vc=V·Gref/G,

whereby Vc would be equal to V when the object is at the reference distance.

The use of a distance sensor offers additional features in various applications of the gesture detection system. The distance information produced by distance sensor 22 may be added as a z-component to the available x- and y-components of the corrected motion vector Vc. The system may then detect three-dimensional gestures without additional hardware cost.

In typical gesture detection applications, the pointer object may be the user's hand moved in front of the screen of a hand-held device. The system would be designed to respond to the hand appearing and moving in the field of view of the image sensor 18. When the hand is not in the field of view, the image sensor could capture remote parasitic elements and confuse them with pointer objects. To avoid this situation, the system may be configured to become unresponsive when the distance produced by the distance sensor is above a threshold, for instance one meter for hand-held devices.

Similarly, the system may be configured to also become unresponsive when the distance produced by the distance sensor is below a threshold (e.g., one centimeter), to avoid reacting to parasitic objects that are too close to the device. For example, this may occur when the hand-held device is put in the user's pocket.

Various changes may be made to the embodiments in light of the above-detailed description. For instance, although a particular type of distance sensor has been disclosed, other types of distance sensors may be used. In general, in the following claims, the terms used should not be construed to limit the claims to the specific embodiments disclosed in the specification and the claims, but should be construed to include all possible embodiments along with the full scope of equivalents to which such claims are entitled. Moreover, it should also be noted that the operations described herein may be implemented using a non-transitory computer-readable medium having computer-executable instructions for causing a mobile or hand-held electronic device to perform the noted operations.

That which is claimed is:

1. A method for measuring motion comprising:
moving an object in a field of view of an image sensor array;
producing two-dimensional motion information of the object from an output of the image sensor array;
measuring a distance between the object and the image sensor array; and
correcting the motion information based on the measured distance.

2. The method of claim 1 wherein measuring the distance comprises measuring the distance with an optical time of flight sensor.

3. The method of claim 1 wherein producing comprises producing a two-dimensional motion vector as the motion information; wherein correcting comprises correcting the motion vector linearly based on the measured distance; and further comprising adding a third dimension to the corrected motion vector based on the measured distance.

4. The method of claim 1 further comprising:
responding to the corrected motion information when the measured distance is below a threshold; and
ignoring the motion information when the measured distance is above the threshold.

5. The method of claim 1 further comprising:
responding to the corrected motion information when the measured distance is above a threshold; and
ignoring the motion information when the measured distance is below the threshold.

6. The method of claim 1 wherein measuring comprises measuring the distance between the object and the image sensor array using a distance sensor comprising at least one Single Photon Avalanche Diode (SPAD).

7. The method of claim 1 further comprising determining a gesture associated with the object based upon the corrected motion information.

8. A system for measuring motion of an object comprising:
an image sensor array;
a distance sensor configured to measure a distance between the object and the image sensor array;
a motion sensor connected to the image sensor array and configured to produce motion information of the object; and
a correction circuit connected to the motion sensor and the distance sensor and configured to correct the motion information based on the distance measured by the distance sensor.

9. The system of claim 8 wherein said distance sensor comprises an optical time of flight sensor.

10. The system of claim 9 further comprising a pulsed infrared laser emitter, and wherein said optical time of flight sensor and said image sensor array are responsive to the infrared laser emitter.

11. The system of claim 8 wherein said distance sensor comprises at least one Single Photon Avalanche Diode (SPAD).

12. The system of claim 8 further comprising a processor coupled to the correction circuit and configured to determine a gesture associated with the object based upon the corrected motion information.

13. A mobile electronic device comprising:
an image sensor array;
a distance sensor configured to measure a distance between the object and the image sensor array;
a motion sensor connected to the image sensor array and configured to produce motion information of the object; and
a correction circuit connected to the motion sensor and the distance sensor and configured to correct the motion information based on the distance measured by the distance sensor.

14. The mobile electronic device of claim 13 wherein said distance sensor comprises an optical time of flight sensor.

15. The mobile electronic device of claim 14 further comprising a pulsed infrared laser emitter, and wherein said optical time of flight sensor and said image sensor array are responsive to the infrared laser emitter.

16. The mobile electronic device of claim 13 wherein said distance sensor comprises at least one Single Photon Avalanche Diode (SPAD).

17. The mobile electronic device of claim 13 further comprising a processor coupled to the correction circuit and configured to determine a gesture associated with the object based upon the corrected motion information.

18. A non-transitory computer-readable medium having computer-executable instructions for causing a mobile electronic device comprising an image sensor array to perform steps comprising:
producing two-dimensional motion information for an object moving in a field of view of the image sensor array based upon an output of the image sensor array;
measuring a distance between the object and the image sensor array; and
correcting the motion information based on the measured distance.

19. The non-transitory computer-readable medium of claim 18 wherein the electronic device further comprises an optical time of flight sensor; and wherein measuring the distance comprises measuring the distance with an optical time of flight sensor.

20. The non-transitory computer-readable medium of claim 18 wherein producing comprises producing a two-dimensional motion vector as the motion information; wherein correcting comprises correcting the motion vector linearly based on the measured distance; and further having computer-executable instructions for causing the electronic device to add a third dimension to the corrected motion vector based on the measured distance.

21. The non-transitory computer-readable medium of claim 18 further having computer-executable instructions for causing the mobile electronic device to perform steps comprising:
responding to the corrected motion information when the measured distance is below a threshold; and
ignoring the motion information when the measured distance is above the threshold.

22. The non-transitory computer-readable medium of claim 18 further having computer-executable instructions for causing the mobile electronic device to perform steps comprising:
responding to the corrected motion information when the measured distance is above a threshold; and
ignoring the motion information when the measured distance is below the threshold.

23. The non-transitory computer-readable medium of claim 18 wherein measuring comprises measuring the distance between the object and the image sensor array based upon a distance sensor comprising at least one Single Photon Avalanche Diode (SPAD).

24. The non-transitory computer-readable medium of claim 18 further having computer-executable instructions for causing the mobile electronic device to determine a gesture associated with the object based upon the corrected motion information.
